(19) United States
(12) Patent Application Publication
(10) Pub. No.: US 2017/0250036 A1
(43) Pub. Date: Aug. 31, 2017

(54) Switch Structure

(71) Applicant: UBIQCONN TECHNOLOGY, INC., Taipei City (TW)

(72) Inventors: HSIN-AN HSU, Taipei City (TW); HSUN-CHANG YANG, Taipei City (TW)

(21) Appl. No.: 15/195,209

(22) Filed: Jun. 28, 2016

(30) Foreign Application Priority Data
Feb. 25, 2016 (TW) 105105713

(51) Int. Cl. H01H 9/04; H01R 24/60; H01R 13/52

(52) U.S. Cl. CPC H01H 9/042; H01R 13/5202; H01R 24/60; H01R 2107/00

(57) ABSTRACT

A switch structure has a housing and a cover. The housing includes a receiving portion and the position point, the position point is disposed at a groove wall of the receiving portion. The cover is pivotally connected to the housing, the cover system can be received in the receiving portion. The cover comprises a position sheet. The position sheet has at least one elastic section and a fixed point. The fixed point corresponds to the position point. The fixed point has a fixing direction corresponding to the position point. The elastic section has an elastic direction. The elastic direction and the fixing direction are substantially parallel.

### BACKGROUND OF THE INVENTION

1. Field of the Invention

The present invention relates to a switch structure, particularly to a switch structure applicable to an electronic device.

2. Description of the Related Art

Nowadays electronic devices with screens are mostly provided to transportation (e.g. aircraft, shuttle, taxi) for passengers to watch and use. Various connection interfaces such as USB and ESATA are also provided with the electronic device for the operators to provide more services for users.

However, dust or liquid may easily come into the connection interface, causing damage to the electronic device. Therefore, a cover is additionally provided for protecting the connection interface. But nowadays it is neither convenient to operate the switch of a cover nor easy to open the cover. It is cumbersome and complex to manufacture the switch of the cover.

### SUMMARY OF THE INVENTION

The problem to be solved by the present invention is to provide an easy-to-operate switch structure.

To solve the problem described above, the present invention provides a switch structure, which includes a housing and a cover. The housing includes a receiving portion and a position point. The position point is disposed at a groove wall of the receiving portion. The cover, which is pivotally connected to the housing, can be received in the receiving portion. The cover comprises a position sheet which has at least one elastic section and a fixed point. The fixed point corresponds to the position point, and has a fixing direction corresponding to the position point. The elastic section has an elastic direction. The elastic direction and the fixing direction are substantially parallel.

The present invention also provides another embodiment, in which the position point is a groove, and the fixed point is a bump. The bump is provided with a guide slope.

The present invention further provides another embodiment, in which the position sheet includes a pressing section and two of the said elastic sections. The two elastic sections are disposed at two ends of the pressing section respectively.

The present invention further provides another embodiment, in which the pressing section is provided with a fixed hole, and the cover comprises a fixed portion corresponding to the fixed hole. When a fixing rod passes through the fixed hole and fixed at the fixed portion, the fixing rod and the elastic direction are substantially perpendicular.

The present invention further provides another embodiment, in which the receiving portion is provided with a connection interface and a waterproof ring. The waterproof ring surrounds the edge of the connection interface.

The present invention further provides another embodiment, in which the cover is provided with a protruding ring. When the cover is received in the receiving portion, the protruding ring corresponds in position to the waterproof ring. The protruding ring will be pressed in position to the waterproof ring, which achieves waterproof and dustproof effects.

The present invention further provides another embodiment, in which the position sheet is integrally molded. The cross-sectional area of the elastic section is less than the cross-sectional area of the pressing section. Thereby, the rigidity of the elastic section is less than the rigidity of the pressing section.

The present invention further provides another embodiment, in which the elastic section includes a fixed end fixed at the cover.

Through the aforementioned embodiment, the switch structure provided in the present invention has at least the following advantages: as the fixing direction of the position point and the fixed point is substantially parallel to the elastic direction of the elastic section, the position sheet is deformable, such that the fixed point and the position point can be separated from each other, and the cover can be moved out of the receiving portion.

### BRIEF DESCRIPTION OF THE DRAWINGS

FIG. 1 is a perspective view of a switch structure in the present invention;

FIG. 2 is an exploded view of the switch structure in the present invention;

FIG. 3 is a schematic drawing showing a closed state of the switch structure in the present invention; and

FIG. 4 is a schematic drawing showing an open state of the switch structure in the present invention.

### DETAILED DESCRIPTION OF THE PREFERRED EMBODIMENT

Hereafter, the technical content of the present invention will be better understood with reference to preferred embodiments.

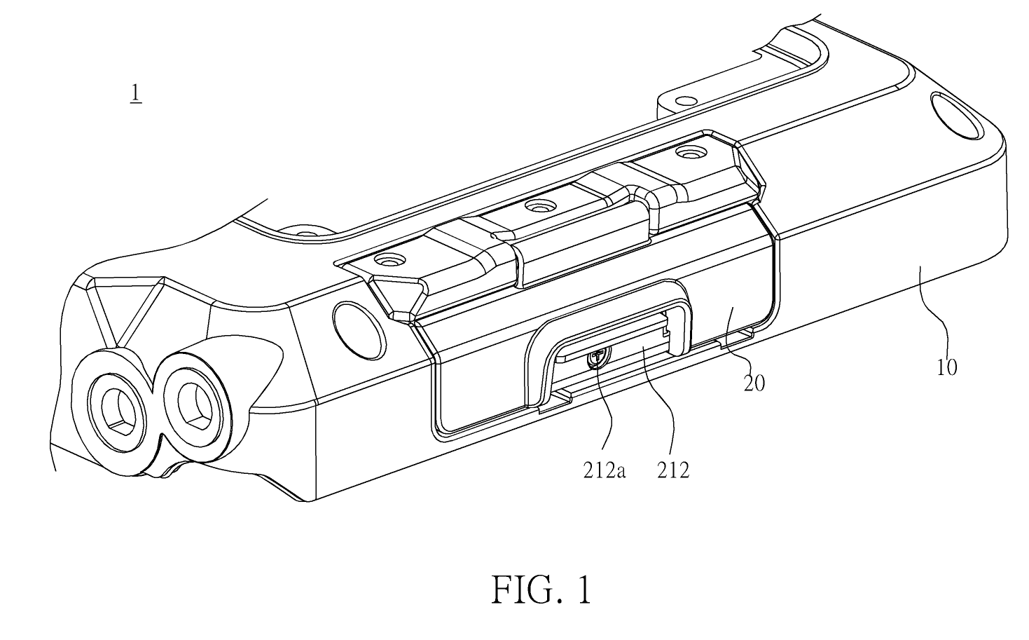

Referring to FIG. 1. The present invention provides a switch structure 1, which includes a housing 10 and a cover 20. In the present invention embodiment, the switch structure 1 is applicable to an electronic device (not shown), which provides a connector plug interface (e.g. USB) through the housing 10 for connection to the electronic device.

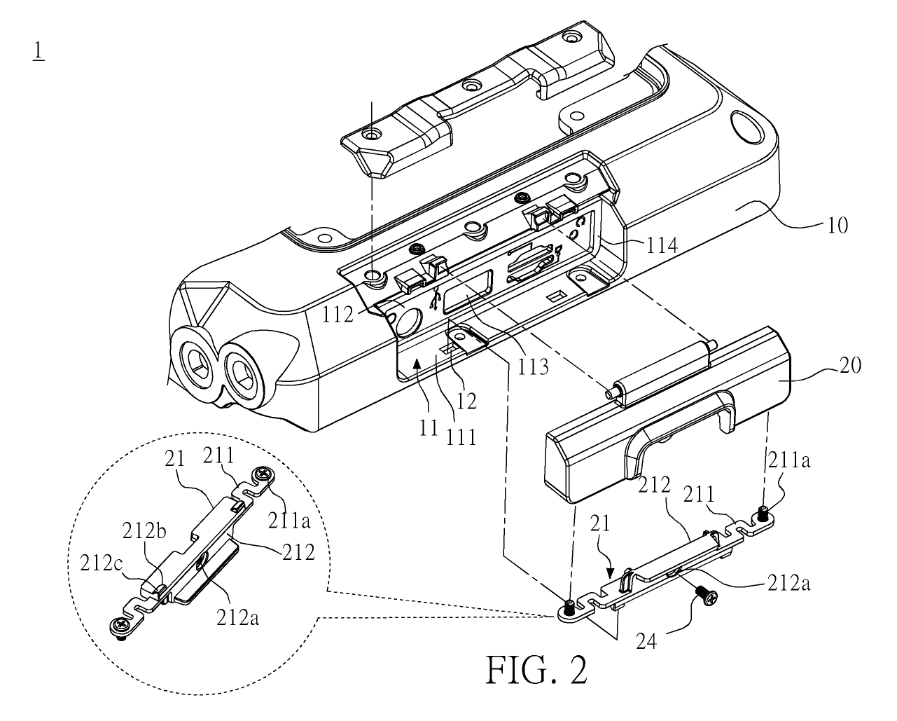

Referring to FIG. 2. The housing 10 includes a receiving portion 11 and a position point 12. The receiving portion 11 has a groove wall 111 and a connection interface 112. The receiving portion 11 is a recessed groove formed by the groove wall 111 and the connection interface 112. The groove wall 111 is a sidewall of the receiving portion 11, and the connection interface 112 is located at the bottom wall of the receiving portion 11. The connection interface 112 is provided with a plurality of openings 113 for connection with a connector (e.g. USB). The position point 12 is disposed at the groove wall 111. In an embodiment of the present invention, the position point 12 is formed by a groove concavely provided by the groove wall 111. The connection interface 112 is further provided with a waterproof ring 114 which surrounds the edge of the connection interface 112. In the embodiment of the present invention, the waterproof ring 114 may be made of foam material or rubber material.

The cover 20 includes a position sheet 21 which is integrally molded from plastics. The position sheet 21 includes a pressing section 212 and two elastic sections 211. The two elastic sections 211 are provided on two sides of the pressing section 212 respectively. The elastic sections 211 are in a curved shape. Since the cross-sectional area of the elastic section 211 is less than the cross-sectional area of the pressing section 212, the rigidity of the elastic section 211 is less than the rigidity of the pressing section 212. When the pressing section 212 is forced, the elastic section 211 is likely to be deformed easily. Thus, it is relatively simple to manufacture the position sheet 21. A free end of the elastic section 211 is a fixed end 211a. In the embodiment of the present invention, the fixed end 211a is provided with a screw.

The cross-sectional area of the pressing section 212 is L-shaped. One side of the pressing section 212 and the elastic section 211 are in the same planar direction. The planar direction of the opposite side of the pressing section 212 is substantially perpendicular to the planar direction of the elastic section 211. The pressing section 212 is provided with a fixed hole 212a and a fixed point 212b. The fixed hole 212a is disposed at one side where the pressing section 212 is perpendicular to the elastic section 211. Its function is described hereinafter. The fixed point 212b is disposed at one side where the pressing section 212 and the elastic section 211 are in the same direction, and is located on one side away from the fixed hole 212a. In an embodiment of the present invention, the fixed point 212b is a bump and provided with a guide slope 212c. The fixed point 212b corresponds to the position point 12. Its function is described hereinafter.

Referring to FIGS. 2, 3, and 4. A fixed portion 22 is provided at the position on the cover 20 corresponding to the fixed hole 212a. In an embodiment of the present invention, the fixed portion 22 is a hollow cylinder in which threads are provided. The cover 20 is further provided with a protruding ring 23. The protruding ring 23 is provided at the position on the cover 20 corresponding to the waterproof ring 114.

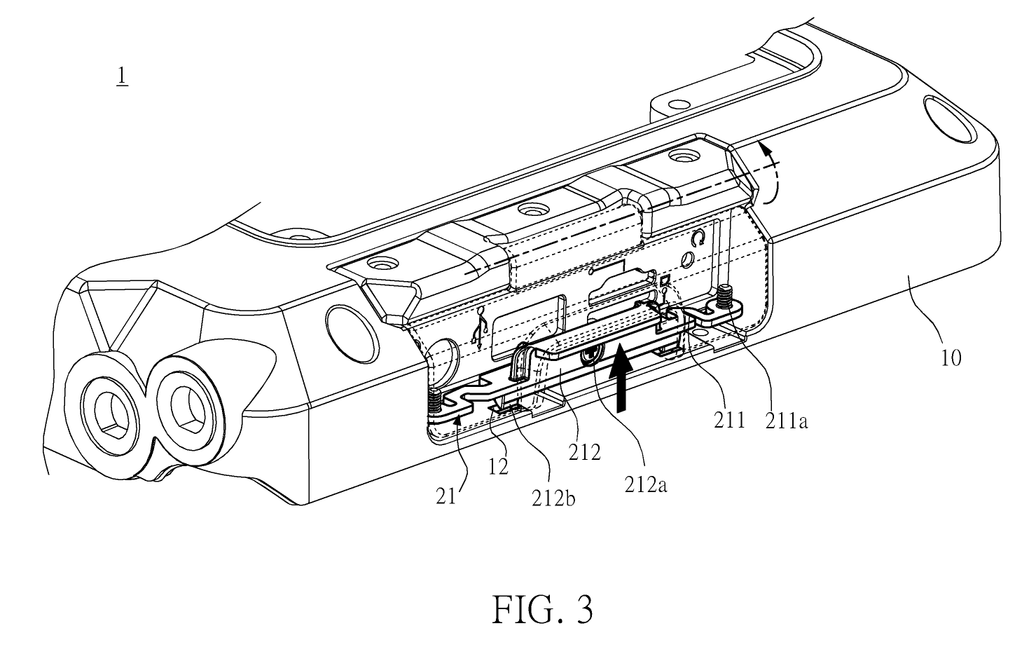

Referring to FIG. 3. The position sheet 21 is fixed onto the cover 20 through the fixed end 211a of the two elastic sections 211. The position point 12 and the fixed point 212b relatively correspond to a fixing direction. The pressing section 212 provides a pressing direction, and the elastic section 211 provides an elastic direction. The fixing direction, the pressing direction and the elastic direction are parallel to each other.

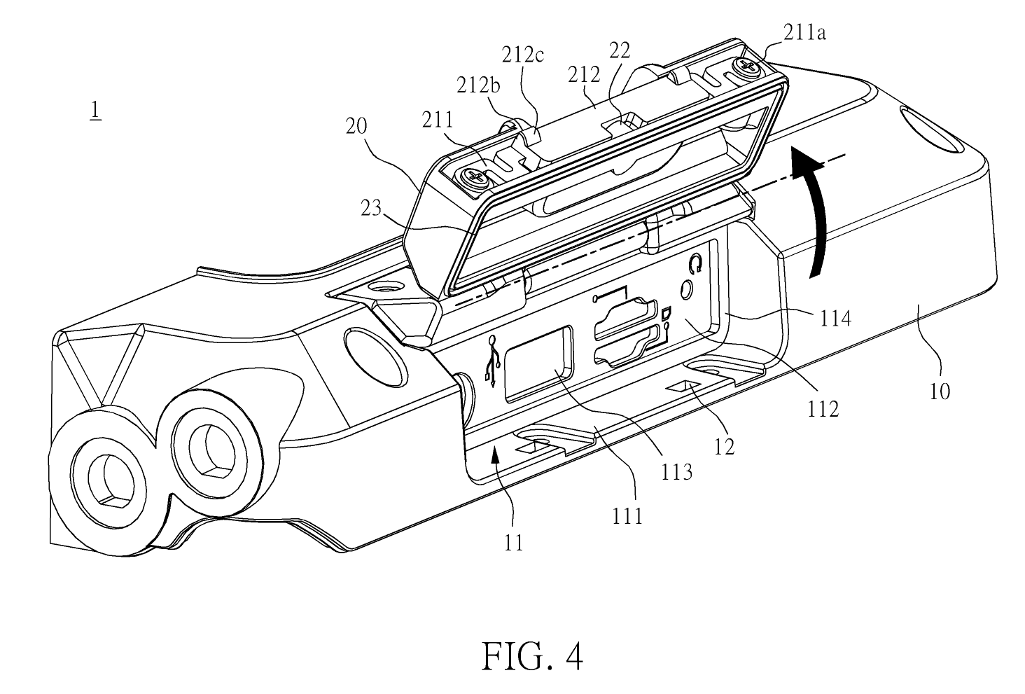

Referring to FIG. 3 and FIG. 4. The cover 20 is pivotally connected to the housing 10, such that the cover 20 can be selectively received in the receiving portion 11. The cover 20 has an open state and a closed state relative to the housing 10, as shown in FIG. 4. In the open state, the cover 20 is not received in the receiving portion 11, such that the connection interface 112 is exposed for a user to plug a connector therein. Referring to FIG. 3. In the closed state, the cover 20 is received in the receiving portion 11, and the fixed point 212b and the position point 12 are fixed each other, that is, the fixed point 212b is disposed within the position point 12. Through the mutual interference of the fixed point 212b and the position point 12, the cover 20 can be securely received in the receiving portion 11. Meanwhile, the waterproof ring 114 corresponds to the protruding ring 23, and the protruding ring 23 can be pressed to the waterproof ring 114, causing waterproof ring 114 and the cover 20 to be substantially fully closed. This achieves waterproof and dustproof effects.

When a user wants to change the state of the cover 20 from a closed state to an open state, the user forces the pressing section 212 in the pressing direction (in an upward direction as shown in the figure) such that the elastic section 211 is deformed in the elastic direction, and the pressing section 212 is displaced. That is, the fixed point 212b is out of the position point 12, such that the fixed point 212b and the position point 12 no longer interfere with each other. Therefore, the cover 20 can be moved out of the receiving portion 11 and changed from the closed state to the open state. It is specifically noted that the direction described here is for illustrating the relative relationship between the force direction and structure, and shall not be limited to the direction of the reality.

When a user wants the switch structure 1 not easy to open, in the closed state, through a fixing rod 24 which passes through a fixed hole 212a, and then is fixed at the fixed portion 22, a longitudinal direction of the fixing rod 24 and an elastic direction of the elastic section 211 are substantially perpendicular, such that the pressing section 212 cannot be moved easily. That is, the cover 20 can be fixed within the receiving portion 11. Through latching the fixed hole 212a and the fixed portion 22 by the fixing rod 24, the cover 20 cannot be opened, such that the switch structure 1 meets explosion-proof specifications.

When a user wants to change the state of the cover from an open state to a closed state, the fixed point 212b touches the groove wall 111 of the receiving portion 11, such that the pressing section 212 is slightly displaced, and the elastic section 211 is deformed. When the fixed point 212b and the position point 12 are fixed each other, the elasticity of the elastic section 211 makes the displacement of the pressing section 212 return to zero. In the process that the fixed point 212b goes into the position point 12 completely, the guide slope 212c makes the displacement of the pressing section 212 return to zero slowly. This can increase product life of the elastic section 211.

As above, the switch structure provided in the present invention has at least the following advantages: as the fixing direction of the position point and the fixed point is substantially parallel to the elastic direction of the elastic section, the position sheet is deformable, such that the fixed point and the position point can be separated from each other, and thus the cover can be moved out of the receiving portion. This provides relatively simple operations.

The preferred embodiment of the present invention described here is only illustrative. To avoid redundancy, all the possible combinations of changes are not documented in detail. However, it shall be understood by those skilled in the art that each of the modules or elements described above may not be necessary. For the implementation of the present invention, the present invention may also contain other detailed, conventional modules or elements. Each module or component is likely to be omitted or modified depending on the needs. Other modules or elements may exist between two of any modules.

It should be noted that the described embodiments are only for illustrative and exemplary, and that various changes and modifications may be made to the described embodiments without departing from the scope of the invention as disposed by the appended claims.

What is claimed is:

1. A switch structure, comprising:
a housing, which includes a receiving portion and a position point, the position point is disposed at a groove wall of the receiving portion; and
a cover, which is pivotally connected to the housing and can be received in the receiving portion, the cover comprising a position sheet having at least one elastic section and a fixed point corresponding to the position point, the fixed point having a fixing direction corresponding to the position point, the elastic section having an elastic direction, the elastic direction and the fixing direction are substantially parallel.

2. The switch structure as claimed in claim 1, wherein the position sheet comprises a pressing section having two of the said elastic sections, and the two elastic sections are disposed at two ends of the pressing section respectively.

3. The switch structure as claimed in claim 2, wherein the position sheet is integrally molded, and the cross-sectional area of the elastic section is less than the cross-sectional area of the pressing section, such that the rigidity of the elastic section is less than the rigidity of the pressing section.

4. The switch structure as claimed in claim 3, wherein the position point is a groove, and the fixed point is a bump which has a guide slope.

5. The switch structure as claimed in claim 4, wherein the pressing section is provided with a fixed hole, and the cover comprises a fixed portion; in the case that the fixed portion corresponds to the fixed hole, a fixing rod passes through the fixed hole and is fixed to the fixed portion, the fixing rod and the elastic direction are substantially perpendicular.

6. The switch structure as claimed in claim 5, wherein the receiving portion is provided with a connection interface and a waterproof ring surrounding the edge of the connection interface.

7. The switch structure as claimed in claim 6, wherein the cover is provided with a protruding ring; in the case that the cover is received in the receiving portion, the protruding ring corresponds in position to the waterproof ring, and the protruding ring is pressed to the waterproof ring, such that the waterproof ring and the cover are closed.

8. The switch structure as claimed in claim 7, wherein the elastic section includes a fixed end, which is fixed at the cover.
